(19) United States
(12) Patent Application Publication
(10) Pub. No.: US 2025/0111610 A1
(43) Pub. Date: Apr. 3, 2025

(54) MULTIMODAL THREE-DIMENSIONAL ASSET SEARCH TECHNIQUES

(71) Applicant: Adobe Inc., San Jose, CA (US)

(72) Inventors: Thibault Groueix, Grenoble (FR); Vladimir Kim, Seattle, WA (US)

(73) Assignee: Adobe Inc., (omitted)

(21) Appl. No.: 18/477,429

(22) Filed: Sep. 28, 2023

(51) Int. Cl. G06T 17/20; G06F 16/58; H04N 13/275

(52) U.S. Cl. CPC G06T 17/20; G06F 16/5866; H04N 13/275

(57) ABSTRACT

A computing system receives a query for a three-dimensional representation of a target object. The query comprises input in the form of text describing the target object, a two-dimensional image of the target object, or a three-dimensional model of the target object. The computing system encodes the input using a machine learning model to generate an encoded representation of the input. The computing system searches a search space using nearest neighbors to identify a three-dimensional representation of the target object. The search space comprises encoded representations of multiple views of a plurality of sample three-dimensional object representations. The computing system outputs the identified three-dimensional representation of the target object.

### TECHNICAL FIELD

This disclosure generally relates to digital assets. More specifically, but not by way of limitation, this disclosure relates to techniques for searching for a three-dimensional object representation based on input that can be accepted in multiple modes including text, two-dimensional images, or three-dimensional models.

### BACKGROUND

Digital assets can take various forms, sharing the fact that they are stored digitally. Examples include images, documents, audio content, video content, and three-dimensional (3D) models. 3D models are representations (e.g., mathematical representations) of an object. The object can be an animal (e.g., human, horse, etc.) or inanimate object (e.g., car, table, etc.). There are various forms of 3D models including a solid model, a shell model, or a mesh. A mesh is a set of interconnected polygons (e.g., triangles, squares, or other polygons) that define the surface of an object.

Tools for searching for digital content are widespread. For instance, web-based search tools can search for text or image data based on input text or image data. Developing such tools becomes increasingly difficult if the content is three-dimensional. Despite the proliferation of searching tools, there is a need for more robust and flexible searching tools.

### SUMMARY

The present disclosure describes techniques for searching for a three-dimensional object representation based on input that can be accepted in multiple modes including text, two-dimensional images, or three-dimensional models.

In some embodiments, given an image, a text, or a 3D model, a 3D content retrieval technique returns a corresponding 3D object representation (e.g., a 3D mesh) that is semantically and geometrically similar to the query. A 3D representation identification system receives an input query which can include text, a 2D image, or a 3D model. The 3D representation identification system identifies a 3D object representation from a database with entries generated using a multi-view encoding technique. The multi-view encoding technique involves rendering multiple views of a 3D model, and encoding these multiple views using a machine learning model (e.g., a visual encoder neural network). This creates a search space.

When a query is received, the 3D representation identification system encodes the input. If the input is an image query, then the 3D representation identification system encodes the image input using a machine learning model such as a visual encoder. If the input is a text query, then the 3D representation identification system encodes the text input using a machine learning model such as a natural language processing (NLP) encoder. If the input is a 3D model, then the 3D representation identification system generates multiple views of the 3D model before encoding each of the views using a machine learning model such as a visual encoder. Using the encoded representation of the input, the 3D representation identification system searches the search space to identify the 3D object representation corresponding to the input. In some examples, the 3D representation identification system uses nearest neighbor techniques to identify the 3D object representation. The 3D representation identification system identifies the corresponding 3D object representation and provides it as output.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing system for 3D representation identification, according to certain embodiments of the present disclosure.

FIG. 2 depicts an example of a flow for 3D representation identification, according to certain embodiments of the present disclosure.

FIG. 3A depicts an example of an input image, according to certain embodiments of the present disclosure.

FIG. 3B depicts an example of an output 3D representation identified based on the input image of FIG. 3A, according to certain embodiments of the present disclosure.

FIG. 4A depicts another example of an input image, according to certain embodiments of the present disclosure.

FIG. 4B depicts an example of an output 3D representation identified based on the input image of FIG. 4A, according to certain embodiments of the present disclosure.

FIG. 5A depicts another example of an input image, according to certain embodiments of the present disclosure.

FIG. 5B depicts an example of an output 3D representation identified based on the input image of FIG. 5A, according to certain embodiments of the present disclosure.

FIG. 6A depicts another example of an input image, according to certain embodiments of the present disclosure.

FIG. 6B depicts an example of an output 3D representation identified based on the input image of FIG. 6A, according to certain embodiments of the present disclosure.

FIG. 7A depicts another example of an input image, according to certain embodiments of the present disclosure.

FIG. 7B depicts an example of an output 3D representation identified based on the input image of FIG. 7A, according to certain embodiments of the present disclosure.

FIG. 8 depicts an example of a computing system that performs certain operations described herein, according to certain embodiments of the present disclosure.

FIG. 9 depicts another example of a computing system that performs certain operations described herein, according to certain embodiments of the present disclosure.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” is used herein to mean “serving as an example, instance, or illustration.” Any embodiment or design described herein as “an example” is not necessarily to be construed as preferred or advantageous over other embodiments or designs. Various embodiments are described herein, including methods, systems, non-transitory computer-readable storage media storing programs, code, or instructions executable by one or more processors, and the like.

The present disclosure describes techniques for identifying a three-dimensional object representation (e.g., a 3D mesh or other type of 3D model), based on a query that can include any of several types of input. The query can include input in the form of text describing a target object, a 2D image of the target object, or a 3D model of the target object. Based on any of these types of input, a 3D representation of the target object is identified.

Once such a query is received, a 3D object representation identification system encodes the input (e.g., the text, 2D image, or 3D model) using a machine learning model to generate an encoded representation of the input. The 3D object representation identification system may include one or more encoder models (e.g., neural networks) that have been trained to generate encoded representations. In some examples, the 3D object representation identification system includes at least two encoders, a text encoder that is configured and trained to encode text and an image encoder that is configured and trained to encode images. Based on the type of input received, the input is routed to the appropriate encoder. In the case of three-dimensional input, the 3D object representation identification system generates multiple views of the three-dimensional input. The 3D object representation identification system generates views from a set of predetermined viewpoints, resulting in a set of two-dimensional images defining the 3D input. Each of these images is then encoded using the image encoder.

The 3D object representation identification system searches a search space using nearest neighbors to identify a three-dimensional representation of the target object. The search space includes encoded representations of multiple views of a plurality of sample three-dimensional object representations. In an initial setup phase, a large dataset of three-dimensional models is obtained. For each of these models, multiple views are generated and encoded in a similar fashion as described above with respect to the runtime process. This generates a search space of encoded views of numerous 3D object representations. By applying a nearest neighbor searching technique, the 3D object representation identification system identifies the 3D object representation that is closest to the target object requested.

The 3D object representation identification system outputs the identified three-dimensional representation of the target object. In some examples, the 3D representation identification system receives the query from a remote client device and transmits the output back to the remote client device.

As an example, based on an input query, “horse,” the 3D object representation identification system identifies and returns a 3D mesh of a horse. Alternatively, the input can be a sketch, photograph, or cartoon of a horse (e.g., a 2D image), and a 3D mesh of a horse is returned. Alternatively, the input can be a 3D model (e.g., another 3D mesh, or a 3D sketch or drawing) of a horse, and a 3D mesh of a horse is returned. Thus, the 3D object representation identification system can accept various modes of query input and identify and return an appropriate 3D object representation.

In typical asset retrieval systems, the result of a query is limited to a certain mode corresponding to the mode of input. For example, systems exist that can retrieve text or images based on text or image input. While there are techniques for searching in three-dimensions, the models are traditionally trained on 3D data and limited to 3D shape categories available during training. Existing systems for 3D content searching typically require creating a large number of renderings, which often does not generalize well to natural images due to rendering artifacts, the presence of complex backgrounds and other objects, and a lack of high quality 3D models. Typically, such systems are limited by the size and diversity of 3D training data and require expensive manual annotation.

The techniques described herein solve these problems and others using a pre-trained text/image co-embedding architecture trained on a large number (e.g., billions) of natural images including shapes of various categories. By providing multiple views of a 3D model to such an architecture, a search space is generated which is rich, robust, and represents 3D models as well as text and images. This enables 3D asset retrieval from queries in text, image, and 3D model form. This creates a streamlined system that can identify 3D image representations based on multiple modes of input, rather than requiring searching different systems depending on the mode of input.

### Example of an Operating Environment for 3D Resource Searching

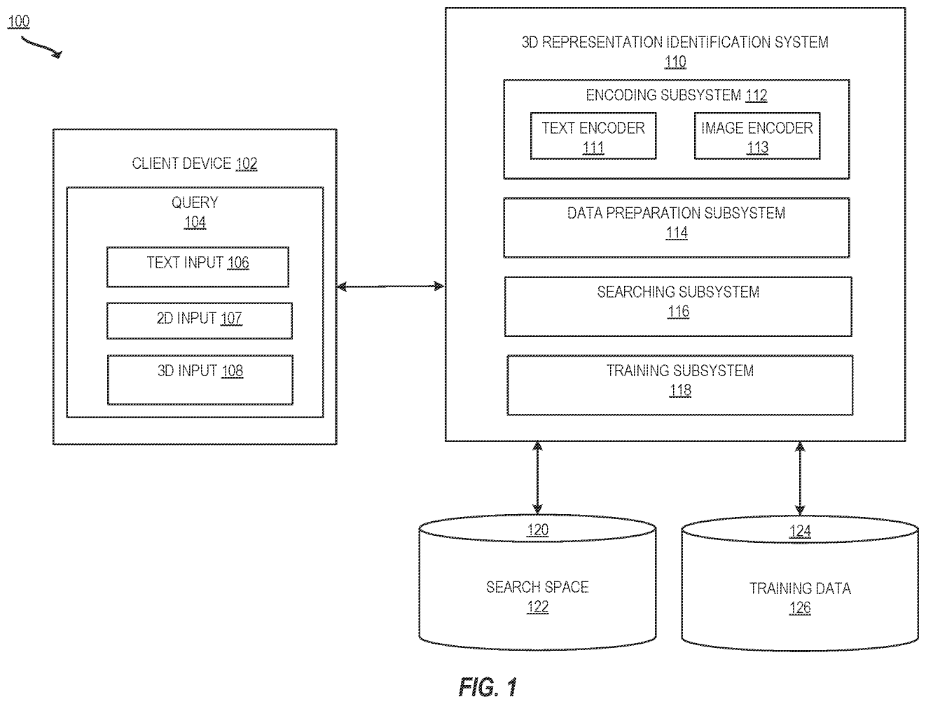

FIG. 1 depicts an example of a computing environment 100 in which 3D resources are identified using a machine learning model configured to accept multimodal input. In the example depicted in FIG. 1, a client device 102 prepares and transmits a query 104 to a 3D representation identification system 110 (e.g., a computing system). The 3D representation identification system 110 identifies a 3D representation as requested by the query 104 by searching a search space 122 using an encoding subsystem 112, data preparation subsystem 114, and searching subsystem 116. The subsystems include one or more trained machine learning models which are trained using a training subsystem 118 using training data 126.

The various subsystems of the 3D representation identification system 110 can be implemented in the same computing system or different, independently operated computing systems. For example, the training subsystem 118 could be a separate entity from the encoding subsystem 112, data preparation subsystem 114, and searching subsystem 116, or the same entity.

Some embodiments of the computing environment 100 include a client device 102. Examples of a client device include, but are not limited to, a personal computer, a tablet computer, a desktop computer, a processing unit, any combination of these devices, or any other suitable device having one or more processors.

The client device 102 is communicatively coupled to the 3D representation identification system 110 via the data network. Examples of the data network include, but are not limited to, internet, local area network (“LAN”), wireless area network, wired area network, wide area network, and the like.

The client device 102 can be used to generate a query 104. The query 104 specifies information to request retrieval of a particular 3D representation of an object, such as a 3D object mesh. The query 104 can include input in multiple modes, including text input 106, 2D input 107, and 3D input 108. The text input 106 specifies the desired object textually (e.g., “mesh of a hippopotamus,” “vase,” etc.). The 2D input 107 is 2D image input such as a drawing or photograph of an object. The 3D input 108 is 3D graphic input such as a 3D model of an object.

In some embodiments, the query 104 is transmitted from the client device 102 to the 3D representation identification system 110 over the data network. The query 104 may, for example, be in the form of a message or Application Programming Interface (API) push or pull.

The 3D representation identification system 110 identifies a 3D representation of a target object based on the received query 104. The 3D representation identification system 110 includes an encoding subsystem 112, data preparation subsystem 114, and searching subsystem 116. The subsystems include one or more trained machine learning models which are trained using a training subsystem 118 using training data 126. In some implementations, the 3D representation identification system 110 further includes, or is communicatively coupled to, one or more data storage units 124 for storing training data 126. The 3D representation identification system 110 further includes, or is communicatively coupled to, one or more data storage units 120 for storing a search space 122.

The encoding subsystem 112 includes one or more machine learning models configured to encode representations of multi-modal input. As illustrated in FIG. 1, the encoding subsystem 112 can include multiple encoders configured to encode different types of multimodal input to an encoded representation corresponding to a search space 122 of three-dimensional object representations. For example, the encoding subsystem 112 can include a text encoder 111 and an image encoder 113.

In some embodiments, the text encoder 111 is a machine learning model configured to encode text. In some implementations, the text encoder 111 is a neural network such as an attention-based transformer. Such a model may include multiple attention layers, and be configured to encode text to a numerical representation. (See Vaswani et al., “Attention is All You Need,” arXiv: 1706.03762 (2017); Radford et al., “Learning Transferable Visual Models From Natural Language Supervision,” in Proceedings of the 38 the International Conference on Machine Learning, PMLR 139 (2021), which are incorporated by reference in their entirety). The text encoder 111 may include at least two, at least three, at least five, at least seven, at least ten, or at least fifteen layers. The text encoder 111 may include at least two layers using a multi-head attention technique (e.g., including a multi-head attention network), at least three layers using a multi-head attention technique, at least five layers using a multi-head attention technique, at least seven layers using a multi-head attention technique, at least ten layers using a multi-head attention technique, or at least fifteen layers using a multi-head attention technique. The multi-head attention technique can include a self-attention technique. Using the multi-head attention technique can include (for example) using a self-attention model, using a multi-head model or using a transformer model.

In some embodiments, the image encoder 113 is an encoder machine learning model configured to configured to encode images. In some implementations, the image encoder 113 is a machine learning model that has been trained to discover an encoded representation of the input image 106. The encoded representation is a string of numbers (e.g., a n-dimensional vector, containing a value for each of the n-dimensions) that represents the image. The image encoder 113 is a machine learning model trained to generate such an encoded representation. The encoder 113 may, for example, be a neural network trained to encode the input image.

In some embodiments, the image encoder 113 includes an input layer, a feature extraction layer, and an output layer. In some implementations, the image encoder 113 is a feed forward neural network. The image encoder 113 may include residual blocks. A residual block is made up of multiple convolutional layers with a skip connection. In some implementations, the residual block includes three convolutional layers followed by a batch normalization layer and a ReLU activation function. In some implementations, the image encoder 113 is, or is similar to, the ResNet-50 network, which is a 50 layer convolutional neural network using residual blocks, as described in detail in He et al., “Deep Residual Learning for Image Recognition,” Proceedings of the IEEE Conference on Computer Vision and Pattern Recognition (CVPR), pp. 770-778 (2015), which is incorporated by reference in its entirety. (See also He et al., “Bag of Tricks for Image Classification with Convolutional Neural Networks,” in Proceedings of the IEEE Conference on Computer Vision and Pattern Recognition, pp. 558-567 (2019); Radford, supra, which are incorporated by reference in their entirety). As another example of a suitable image encoder, a neural network having multiple pooling layers and/or multiple attention layers can be implemented, as described in Zhang, “Making Convolutional Networks Shift-Invariant Again,” arXiv preprint arXiv: 1904.11486 (2019) and Radford, supra, which are incorporated by reference in their entirety.

The data preparation subsystem 114 includes hardware and/or software configured to prepare data for encoding and/or searching. In some instances, the data preparation subsystem 114 is configured to normalize encoded representations. In some instances, the data preparation subsystem 114 is configured to generate views of a three-dimensional model. For example, if the input is in the form of a three-dimensional model, the data preparation subsystem 114 generates two-dimensional views (e.g., dozens or hundreds of views from predetermined perspectives) of the model which can then be encoded by the image encoder 113.

The searching subsystem 116 includes hardware and/or software configured to search the search space 122 based on the encoded and otherwise prepared data processed by the encoding subsystem 112 and data preparation subsystem 114. In some instances, the searching subsystem 116 uses a nearest neighbors algorithm to identify a 3D object representation represented in the search space 122 which is closest to the encoded representation generated based on the query 104.

One or more of the subsystems of the 3D representation identification system 110 include trained machine learning models or include components that use machine learning models that have been trained. For example, in the embodiment depicted in FIG. 1, the training may be performed by a training subsystem 118, which may perform the training using various training data 126. In some implementations, the training subsystem 118 includes, or is communicatively coupled to, one or more data storage units 124 for storing the training data 126.

The training subsystem 118 includes hardware and/or software configured to train one or more of the machine learning models. The training subsystem 118 includes functionality to gather appropriate training data 126, which may be labeled and/or unlabeled. The training subsystem 118 includes functionality to provide the appropriate training data to the corresponding machine learning model. The training subsystem 118 includes functionality to obtain output from the machine learning models. The training subsystem 118 includes functionality to compare the output to the training data, and update parameters of the machine learning models based on the comparison.

In some examples, the machine learning models are neural networks. The training subsystem trains the machine learning models using backpropagation. For example, a neural network receives training data as input and outputs a predicted result. This result is compared to the label assigned to that training data. In some implementations, the comparison is performed by determining gradients based on the input and predicted result (e.g., by minimizing a loss function by computing and minimizing a loss value representing an error between the predicted result and the actual label value). The computed gradient is then used to update parameters of the neural network.

In some examples, the training data 126 includes image-text pairs. In some instances, the text encoder 111 and the image encoder 113 are jointly trained on the training data 126. For example, the encoders are trained to predict the text corresponding to each image. Suitable training techniques are described in further detail in Radford, supra. In some aspects, the text encoder 111 and the image encoder 113 are first pre-trained on a large (e.g., billions, hundreds of millions, millions, or hundreds of thousands of image-text pairs) general purpose dataset. This produces pretrained models, which are then fine-tuned for the specific task of 3D representation retrieval.

The data storage units 120 and 124 can be implemented as one or more databases or one or more data servers. The data storage unit 124 includes training data 126 that is used by the training subsystem 118 and other engines of the 3D representation identification system 110. The data storage unit 120 includes a search space 122. The search space 122 includes encoded representations of various training objects. The search space 122 is generated by encoding multiple views of a set of 3D representations. Multiple views of a 3D model are rendered and then encoded using the image encoder 113. This creates a search space of size “number of models” times “number of rendered views.” This search space is a powerful descriptor for 3D models.

### Examples of Operations for 3D Representation Search

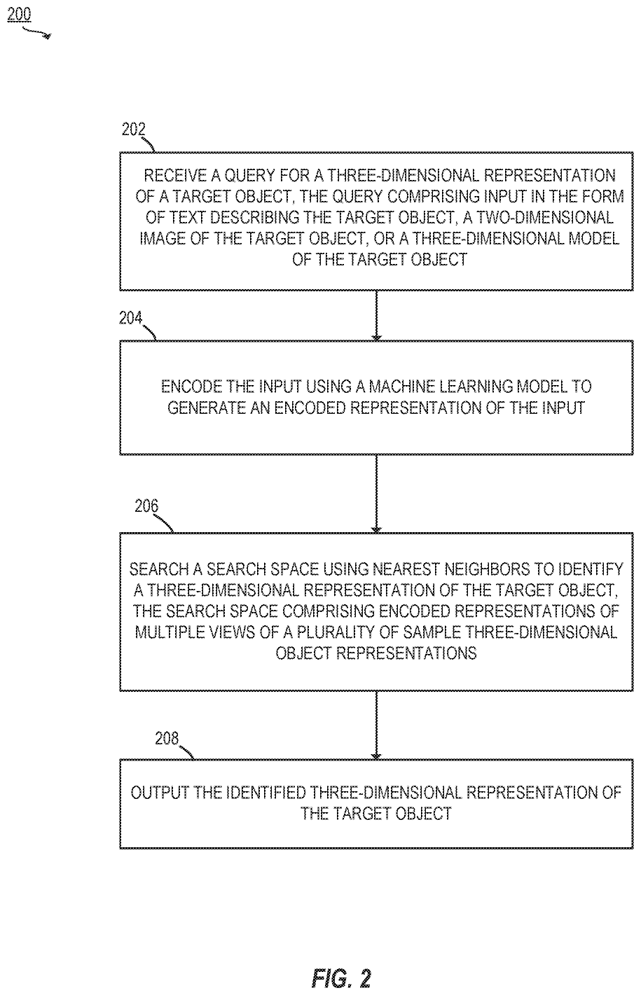

FIG. 2 depicts an example of a flow 200 for identifying a 3D representation based on multimodal input, according to certain embodiments. The operations described with respect to FIG. 2 may be executed by the components depicted in and described above with respect to FIG. 1.

Prior to the processing of the flow 200, initial training and setup may be performed. The initial training can include the 3D representation identification system training the machine learning models (e.g., the text encoder 111 and the image encoder 113), as described above. The initial setup may include the 3D representation identification system generating the search space 122. The 3D representation identification system obtains a set of sample three-dimensional object representations (e.g., 3D meshes). The 3D representation identification system generates multiple views of each of the sample three-dimensional object representations. In some aspects, the multiple views are from a set of predetermined viewpoints. For example, the multiple views of each sample three-dimensional object representation includes at least one hundred views from predetermined viewpoints. Each of these views is processed by the image encoder 113 to generate encoded representations of the views. In some cases, the encoded representations are then normalized. This creates a search space of size “number of 3D object representations” times “number of rendered views.”

In some aspects, in addition to generating the multiple views, the initial setup includes generating encoded representations corresponding to variations of lighting and/or texture. For example, after generating multiple views of a three-dimensional object representation, the 3D representation identification system processes each view to alter the lighting (e.g., lighting that is darker, lighter, and/or from a different angle). Alternatively, or additionally, the 3D representation identification system processes each view to alter the texture (e.g., to alter how rough, smooth, hairy, etc., the surface of the object is). These variations are then encoded. This ultimately helps to obtain a more accurate match as the search space includes a variety of lighting and/or textures, as the input images/3D models often do.

At step 202, the 3D representation identification system receives a query for a three-dimensional representation of a target object. In some instances, the 3D representation identification system 110 receives the query from the client device 102 depicted in FIG. 1. The query includes input in the form of text describing the target object, a two-dimensional image of the target object, or a three-dimensional model of the target object. As described above, the 3D representation identification system is configured to identify a 3D representation based on any of these modes of input. A user may specify the desired three-dimensional model using any of these forms of input. In some examples, the query is received as a request, transmitted over a network from a client device to the 3D representation identification system. For example, the request can be received in the form of a message and/or API call.

At step 204, the 3D representation identification system encodes the input using a machine learning model to generate an encoded representation of the input. As described above with respect to FIG. 1, in some embodiments, the 3D representation identification system includes multiple machine learning models configured to encode text and/or images.

In some instances, the input is in text form. The 3D representation identification system encodes the text using a text encoder. As described above with respect to FIG. 1, the text encoder 111 is a machine learning model configured to encode text. The text encoder may, for example, be a neural network with multiple attention layers. The text is provided as input to the text encoder, which processes the input text and generates an encoded representation of the text.

In some instances, the input is in image form. The 3D representation identification system encodes the text using an image encoder. As described above with respect to FIG. 1, the image encoder 113 is a machine learning model trained to generate an encoded representation of an image. The image encoder may, for example, be a neural network with multiple residual layers and/or multiple attention layers. The image is provided as input to the image encoder, which processes the input image and generates an encoded representation of the image.

In some instances, the input is in the form of a 3D model. The 3D representation identification system generates multiple views of the 3D representation (e.g., 100 views from predetermined viewpoints). Each view is a two-dimensional image. These views or images are input to the image encoder, which processes the images and generates an encoded representation of each image.

In some embodiments, the 3D representation identification system normalizes the encoded representation of the input. For example, the 3D representation identification system computes the L2 norm, or the square root of the sum of the squared vector values, of the encoded representation. In such embodiments, the encoded representations in the search space are also normalized.

At step 206, the 3D representation identification system searches a search space using nearest neighbors to identify a three-dimensional representation of the target object, the search space comprising encoded representations of multiple views of a plurality of sample three-dimensional object representations. In some examples, the three-dimensional object representation is or includes a mesh.

Nearest neighbors, or K Nearest Neighbors (KNN) is a machine learning technique that uses a classifier model to find the smallest distance between data points. Nearest neighbors can be used with different measures of distance, such as cosine, L1, and L2 distance. In some aspects, searching the search space using nearest neighbors comprises minimizing an L2 distance between one or more views in the search space and the encoded input. Alternatively, or additionally, cosine distance, L1 distance, or another suitable distance can be implemented. Nearest neighbor techniques are described in further detail in, e.g., Ramiah, “Machine Learning Basics: KNN, Medium, available at https://madhuramiah.medium.com/an-introduction-to-k-nearest-neighbor-319f23dfe506 (2019), which is incorporated by reference in its entirety.

If the encoded representations are normalized, then the 3D representation identification system searches the search space by comparing the normalized encoded representation of the input to the normalized encoded representations in the search space (e.g., using KNN as described above).

Upon identifying an encoded representation, the 3D representation identification subsystem identifies the corresponding three-dimensional representation of the target object. In some examples, the 3D representation identification subsystem maintains a look-up table which maps encoded representations to three-dimensional representations of the corresponding objects. The look-up table can be used to identify which encoded representations correspond to which three-dimensional object representations in which viewpoints. The 3D representation identification subsystem traverses the look-up table to identify the three-dimensional representation of the target object based on the identified encoded representation.

At step 208, the 3D representation identification system outputs the identified three-dimensional representation of the target object. In some instances, the 3D representation identification system outputs the identified three-dimensional representation of the target object to the client device 102. In some examples, the 3D representation identification system outputs the three-dimensional representation of the target object by transmitting a message (e.g., over a network) which includes the three-dimensional representation of the target object. Alternatively, or additionally, the 3D representation identification system outputs the three-dimensional representation of the target object via an API.

In some examples, the 3D representation identification system is used to automatically tag a 3D asset. For example, when a user uploads a new 3D asset to an existing data set, this 3D asset is provided as input to, and processed by, the 3D representation identification system as described above. This is used to retrieve the most similar 3D asset, which is already annotated. The 3D representation identification system then transfers the annotation to the new asset. This is useful for category labeling and tagging.

In some aspects, the 3D representation identification system is used to generate a 3D model from a rough 3D shape. For example, a user sketches a rough 3D shape, e.g., in a Virtual Reality (VR) environment such as Substance 3D Modeler. This rough 3D shape is provided as input to, and processed by, the 3D representation identification system as described above. The output is a high-quality 3D object representation that can replace the rough sketch. In some cases, this is used for a kit-bashing workflow, where, based on the output 3D image representation, high-quality 3D model parts are suggested.

In some aspects, the 3D representation identification system is used to cast shadows in a 2D image. A 2D image is provided as input to, and processed by, the 3D representation identification system as described above. A 3D model is retrieved and used to cast shadows on the estimated depth map of the input image. In some cases, a user can click on an existing shadow and drag it around to adjust the shadows.

### Examples of Input and Output

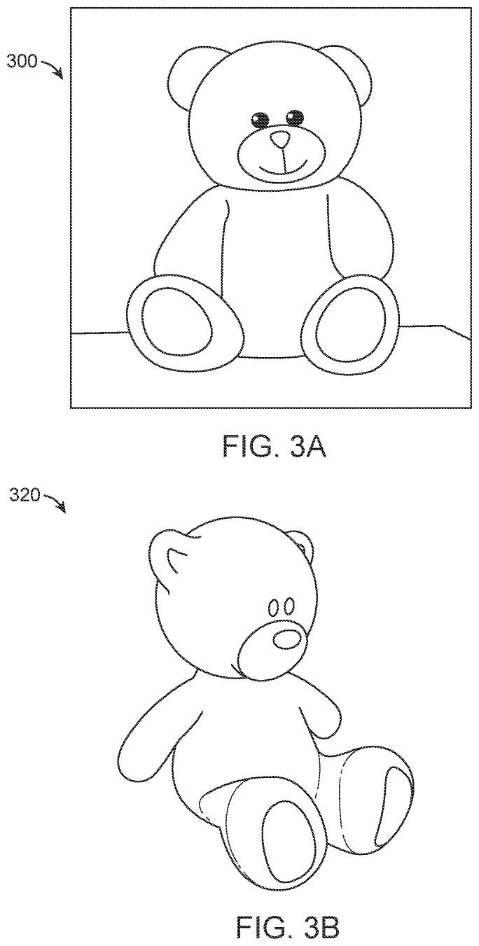

FIGS. 3A-7B illustrate examples of input images and output three-dimensional models that can be identified as described above with respect to FIGS. 1 and 2. The example input images are one of several types of multimodal input that can be accepted, as descried above (e.g., text or three-dimensional models can also be received as input).

FIG. 3A depicts an example of an input image 300, according to certain embodiments of the present disclosure. In this example, the input image 300 is a photograph of a bear toy.

FIG. 3B depicts an example of an output 3D representation 320 identified based on the input image 300 of FIG. 3A, according to certain embodiments of the present disclosure. Based on the image 300 of a bear toy, a corresponding 3D representation 320 of a bear toy is identified using the techniques described herein.

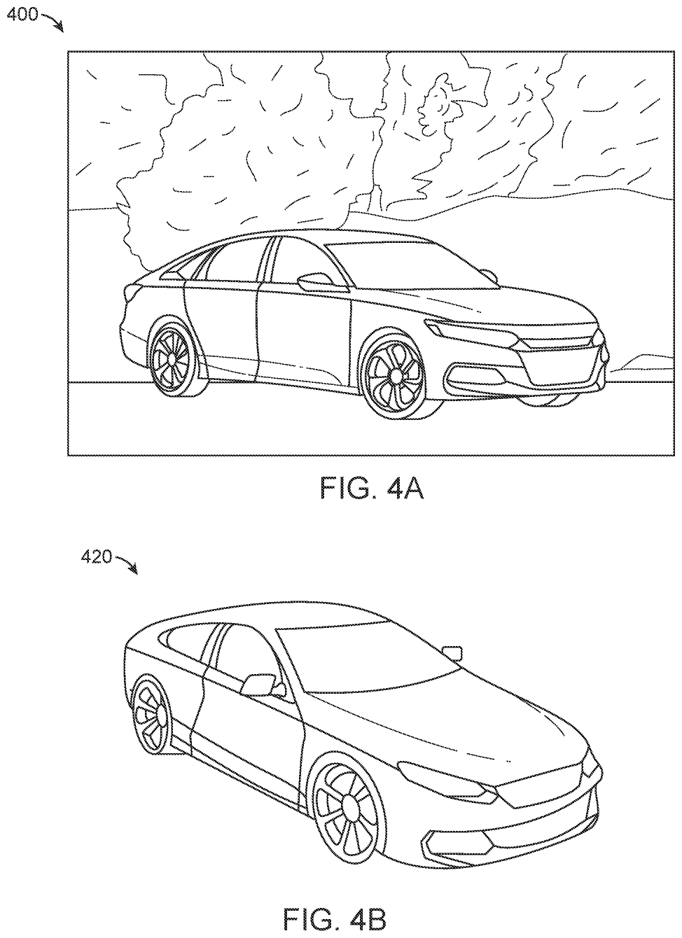

FIG. 4A depicts another example of an input image 400, according to certain embodiments of the present disclosure. In this example, the input image 400 is a photograph of a car.

FIG. 4B depicts an example of an output 3D representation 420 identified based on the input image 400 of FIG. 4A, according to certain embodiments of the present disclosure. Based on the image 400 of a car, a corresponding 3D representation 420 of a car is identified using the techniques described herein. The 3D representation 420 has a similar shape as the car in the input image 400. In some aspects, the system can identify different car models corresponding to different styles of cars.

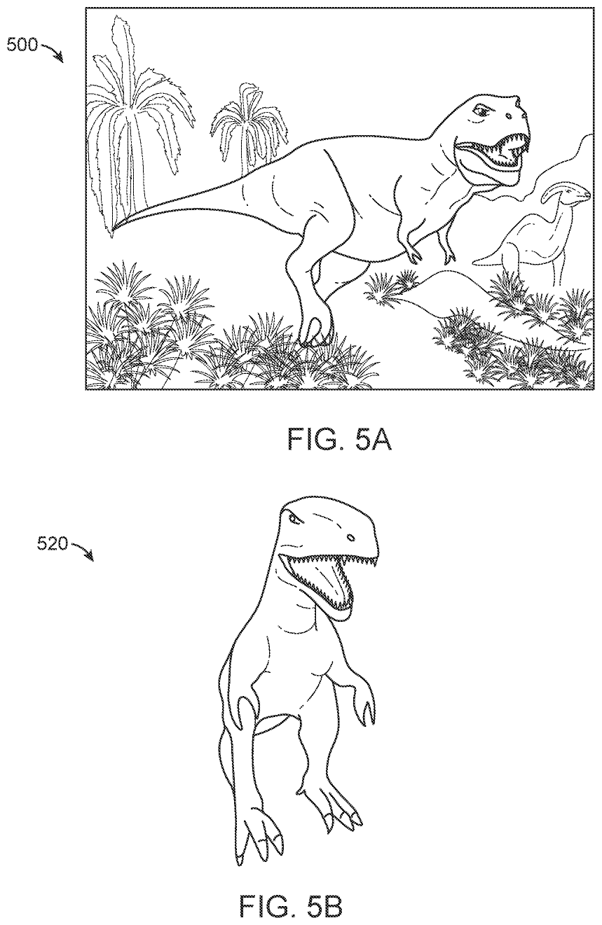

FIG. 5A depicts another example of an input image 500, according to certain embodiments of the present disclosure. In this example, the input image 500 is a drawing of a Tyrannosaurus rex.

FIG. 5B depicts an example of an output 3D representation 520 identified based on the input image 500 of FIG. 5A, according to certain embodiments of the present disclosure. Based on the image 500 of a Tyrannosaurus rex, a corresponding 3D representation 520 of a Tyrannosaurus rex is identified using the techniques described herein. In some aspects, the system can identify different dinosaurs models corresponding to different species of dinosaurs (e.g., a Tyrannosaurus rex, a Stegosaurus, etc.).

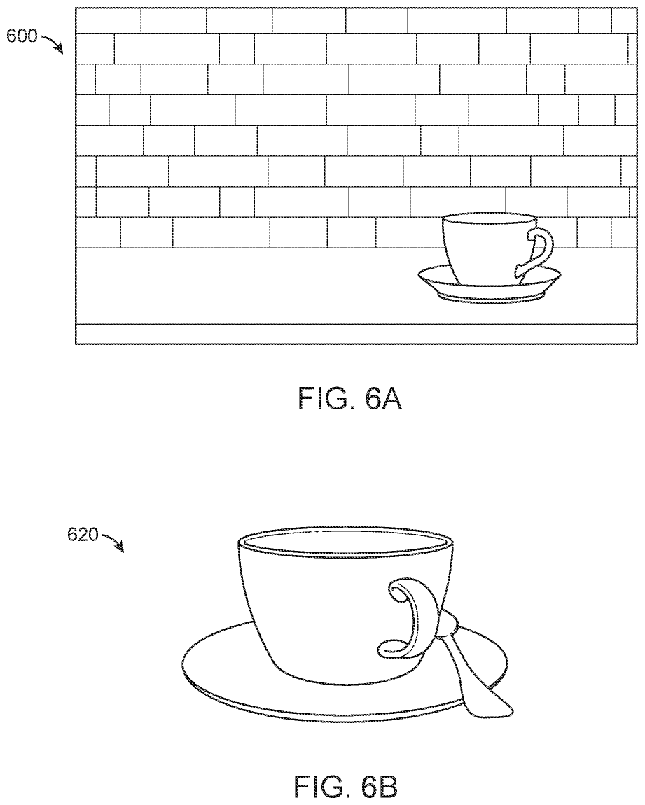

FIG. 6A depicts another example of an input image 600, according to certain embodiments of the present disclosure. In this example, the input image 600 is a photograph of a cup and saucer.

FIG. 6B depicts an example of an output 3D representation 620 identified based on the input image 600 of FIG. 6A, according to certain embodiments of the present disclosure. Based on the image 600 of a cup and saucer, a corresponding 3D representation 620 of a cup and saucer is identified using the techniques described herein.

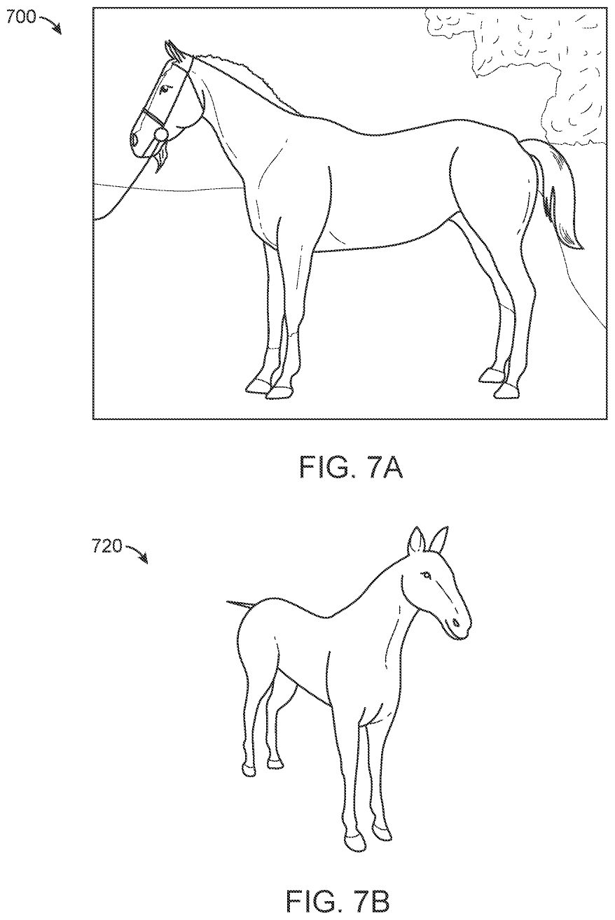

FIG. 7A depicts another example of an input image 700, according to certain embodiments of the present disclosure. In this example, the input image 700 is a photograph of a horse.

FIG. 7B depicts an example of an output 3D representation 720 identified based on the input image 700 of FIG. 7A, according to certain embodiments of the present disclosure. Based on the image 700 of a horse, a corresponding 3D representation 720 of a horse is identified using the techniques described herein.

### Example of a Computing System for 3D Representation Identification

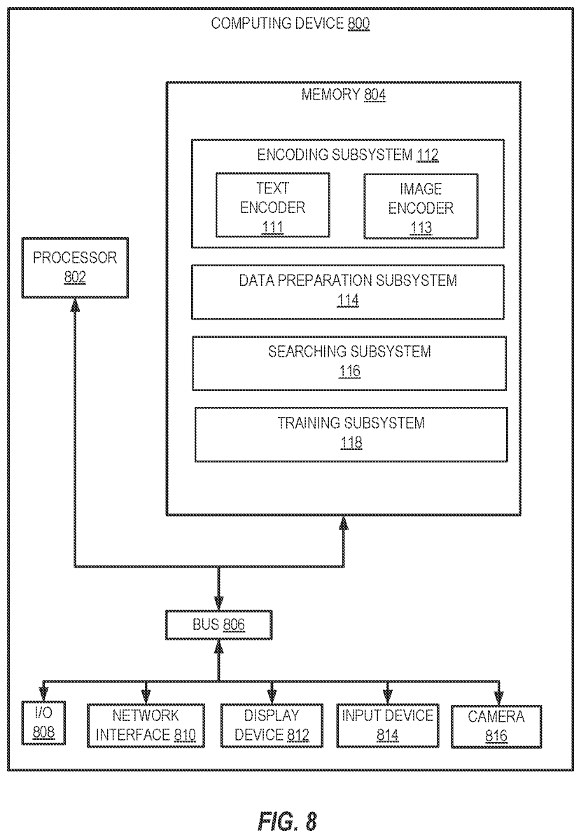

Any suitable computing system or group of computing systems can be used for performing the operations described herein. For example, FIG. 8 depicts examples of a computing device 800 that executes an encoding subsystem 112, data preparation subsystem 114, searching subsystem 116, and training subsystem 118 (as described above with respect to FIG. 1).

The depicted examples of a computing device 800 includes a processor 802 communicatively coupled to one or more memory components 804. The processor 802 executes computer-executable program code stored in a memory component 804, accesses information stored in the memory component 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

The memory component 804 includes any suitable non-transitory computer-readable medium for storing data, program code (e.g., executable instructions), or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing device 800 may also include a number of external or internal devices, such as input or output devices. For example, the computing device 800 is shown with one or more input/output (“I/O”) interfaces 808. An I/O interface 808 can receive input from input devices or provide output to output devices. One or more buses 806 are also included in the computing device 800. The bus 806 communicatively couples one or more components of a respective one of the computing device 800.

The computing device 800 executes program code that configures the processor 802 to perform one or more of the operations described herein. The program code may correspond to the encoding subsystem 112, data preparation subsystem 114, searching subsystem 116, and training subsystem 118, and/or other suitable applications that perform one or more operations described herein. The program code may be resident in the memory component 804 or any suitable computer-readable medium and may be executed by the processor 802 or any other suitable processor. In some embodiments, the encoding subsystem 112, data preparation subsystem 114, searching subsystem 116, and training subsystem 118 are stored in the memory component 804, as depicted in FIG. 8. In additional or alternative embodiments, one or more of the encoding subsystem 112, data preparation subsystem 114, searching subsystem 116, and training subsystem 118 are stored in different memory components of different computing systems. In additional or alternative embodiments, the program code described above is stored in one or more other memory components accessible via a data network.

In some embodiments, one or more of these data sets, models, and functions are stored in the same memory component (e.g., the memory component 804). For example, a device, such as the computing environment 100 depicted in FIG. 1, can host an encoding subsystem 112, data preparation subsystem 114, searching subsystem 116, and training subsystem 118. In additional or alternative embodiments, one or more of the programs, data sets, models, and functions described herein are stored in one or more other memory components accessible via a data network.

The computing device 800 also includes a network interface device 810. The network interface device 810 includes any device or group of devices suitable for establishing a wired or wireless data connection to one or more data networks. Non-limiting examples of the network interface device 810 include an Ethernet network adapter, a modem, and the like. The computing device 800 is able to communicate with one or more other computing devices via a data network using the network interface device 810.

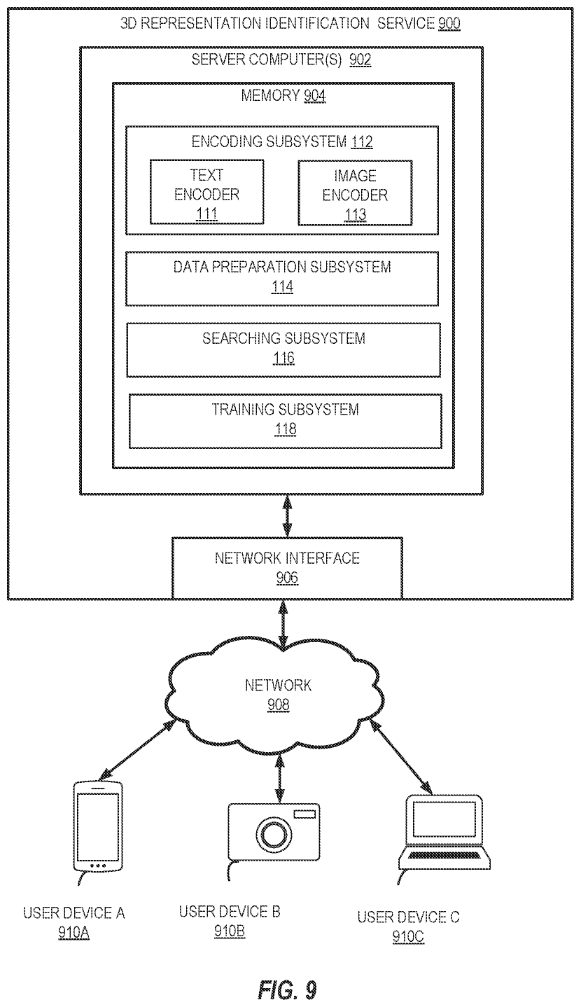

In some embodiments, the functionality provided by the computing device 800 may be offered as a cloud-based 3D asset retrieval service 900 by a cloud service provider. For example, FIG. 9 depicts an example of a cloud-based 3D asset retrieval service 900 offering one or more 3D asset retrieval services that can be used by a number of user subscribers using user devices 910A, 910B, and 910C across a network 908. In certain embodiments, the 3D asset retrieval services provided by the 3D asset retrieval service 900 include a service that identifies and displays information associated with items based on information provided by the user devices 910A, 910B, and 910C. In some cases, the 3D asset retrieval services may be offered under a Software as a Service (SaaS) model. One or more users may subscribe to the 3D asset retrieval services, and the 3D asset retrieval service 900 performs the processing to provide the 3D asset retrieval services to subscribers. The 3D asset retrieval service 900 may include one or more remote server computer(s) 902.

The remote server computer(s) 902 include any suitable non-transitory computer-readable medium for storing program code (e.g., code for the encoding subsystem 112, data preparation subsystem 114, searching subsystem 116, and/or training subsystem 118), which is used by the 3D asset retrieval service 900 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computer(s) 902 can include volatile memory, non-volatile memory, or a combination thereof.

One or more of the server computer(s) 902 execute the program code (e.g., via the encoding subsystem 112, data preparation subsystem 114, searching subsystem 116, and training subsystem 118 that configures one or more processors of the server computer(s) 902 to perform one or more of the operations that provide interactive 3D asset retrieval services, such as gathering an analyzing feedback from multiple users and identifying and recommending items based on the analysis. Any other suitable systems or subsystems that perform one or more operations described herein (e.g., a subsystem for generating tracking information) can also be implemented by the 3D asset retrieval service 900.

In certain embodiments, the 3D asset retrieval service 900 may implement the services by executing program code and/or using program data, which may be resident in a memory component of the server computer(s) 902 or any suitable computer-readable medium and may be executed by the processors of the server computer(s) 902 or any other suitable processor.

The 3D asset retrieval service 900 also includes a network interface device 906 that enables communications to and from the 3D asset retrieval service 900. In certain embodiments, the network interface device 906 includes any device or group of devices suitable for establishing a wired or wireless data connection to the network 908. Non-limiting examples of the network interface device 906 include an Ethernet network adapter, a modem, and/or the like. The 3D asset retrieval service 900 is able to communicate with the user devices 910A, 910B, and 910C via the network 908 using the network interface device 906.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method comprising:
receiving, by a computing system, a query for a three-dimensional representation of a target object, the query comprising input in the form of text describing the target object, a two-dimensional image of the target object, or a three-dimensional model of the target object;
encoding, by the computing system using a machine learning model, the input to generate an encoded representation of the input;
searching, by the computing system, a search space using nearest neighbors to identify a three-dimensional representation of the target object, the search space comprising encoded representations of multiple views of a plurality of sample three-dimensional object representations; and
outputting, by the computing system, the identified three-dimensional representation of the target object.

2. The method of claim 1, wherein the input comprises the three-dimensional model of the target object, and wherein the method further comprises:
generating multiple views of the three-dimensional model; and
encoding each of the multiple views using the machine learning model.

3. The method of claim 1, wherein:
the input comprises the text describing the target object; and
the machine learning model comprises a text encoder.

4. The method of claim 1, wherein:
the input comprises the two-dimensional image describing the target object; and
the machine learning model comprises an image encoder.

5. The method of claim 1, further comprising:
normalizing the encoded representation of the input,
wherein the encoded representations of the plurality of sample three-dimensional object representations in the search space are normalized, and wherein the searching comprises comparing the normalized encoded representation of the input to the normalized encoded representations in the search space.

6. The method of claim 1, wherein searching the search space using nearest neighbors comprises minimizing an L2 distance between one or more of the encoded representations of multiple views of the plurality of sample three-dimensional object representations in the search space and the encoded input.

7. The method of claim 1, wherein the multiple views of each of the plurality of sample three-dimensional object representations comprises at least one hundred views from predetermined viewpoints.

8. The method of claim 1, wherein the multiple views of each of the plurality of sample three-dimensional object representations comprise views from predetermined viewpoints, and one or more of views with varying lighting or views with varying texture.

9. The method of claim 1, wherein the machine learning model comprises a neural network having multiple attention layers.

10. The method of claim 1, wherein the three-dimensional object representation comprises a mesh.

11. A system comprising:
a memory component; and
a processing device coupled to the memory component, the processing device configured to perform operations comprising:
receiving, by a computing system, a query for a three-dimensional representation of a target object, the query comprising input in the form of text describing the target object, a two-dimensional image of the target object, or a three-dimensional model of the target object;
encoding, by the computing system using a machine learning model, the input to generate an encoded representation of the input;
searching, by the computing system, a search space using nearest neighbors to identify a three-dimensional representation of the target object, the search space comprising encoded representations of multiple views of a plurality of sample three-dimensional object representations; and
outputting, by the computing system, the identified three-dimensional representation of the target object.

12. The system of claim 11, wherein the input comprises the three-dimensional model of the target object, and wherein the operations further comprise:
generating multiple views of the three-dimensional model; and
encoding each of the multiple views using the machine learning model.

13. The system of claim 11, wherein:
the input comprises the text describing the target object; and
the machine learning model comprises a text encoder.

14. The system of claim 11, wherein:
the input comprises the two-dimensional image describing the target object; and
the machine learning model comprises an image encoder.

15. The system of claim 11, the operations further comprising:
normalizing the encoded representation of the input,
wherein the encoded representations of the plurality of sample three-dimensional object representations in the search space are normalized, and wherein the searching comprises comparing the normalized encoded representation of the input to the normalized encoded representations in the search space.

16. The system of claim 11, wherein the multiple views of each of the plurality of sample three-dimensional object representations comprise views from predetermined viewpoints, and one or more of views with varying lighting or views with varying texture.

17. A non-transitory computer-readable medium storing executable instructions, which when executed by a processing device, cause the processing device to perform operations comprising:
receiving, by a computing system, a query for a three-dimensional representation of a target object, the query comprising input in the form of text describing the target object, a two-dimensional image of the target object, or a three-dimensional model of the target object;
encoding, by the computing system using a machine learning model, the input to generate an encoded representation of the input;
searching, by the computing system, a search space using nearest neighbors to identify a three-dimensional representation of the target object, the search space comprising encoded representations of multiple views of a plurality of sample three-dimensional object representations, the multiple views comprising views from a set of predetermined viewpoints; and
outputting, by the computing system, the identified three-dimensional representation of the target object.

18. The medium of claim 17, wherein the input comprises the three-dimensional model of the target object, and wherein the operations further comprise:
generating multiple views of the three-dimensional model; and
encoding each of the multiple views using the machine learning model.

19. The medium of claim 17, the operations further comprising:
normalizing the encoded representation of the input,
wherein the encoded representations of the plurality of sample three-dimensional object representations in the search space are normalized, and wherein the searching comprises comparing the normalized encoded representation of the input to the normalized encoded representations in the search space.

20. The medium of claim 17, wherein the multiple views of each of the plurality of sample three-dimensional object representations comprise one or more of views with varying lighting or views with varying texture.
